(19) United States
(12) Patent Application Publication
(10) Pub. No.: US 2008/0159143 A1
(43) Pub. Date: Jul. 3, 2008

(54) LINK SIGNAL-TO-NOISE AWARE ROUTING OVER MOBILE AD HOC NETWORKS (MANETS)

(75) Inventors: Ramesh Nagarajan, Princeton Junction, NJ (US); Shyam P. Parekh, Orinda, CA (US); Kiran M. Rege, Marlboro, NJ (US)

Correspondence Address: SYNNESTVEDT & LECHNER, LLP, 1101 MARKET STREET, SUITE 2600, PHILADELPHIA, PA, 19107-2950, US

(73) Assignee: LUCENT TECHNOLOGIES INC., Murray Hill, NJ (US)

(21) Appl. No.: 11/617,858

(22) Filed: Dec. 29, 2006

(51) Int. Cl. G08C 15/00

(52) U.S. Cl. 370/235

(57) ABSTRACT

The present invention provides a method and apparatus for routing a data flow from a source node to a destination node in a mobile ad-hoc network (MANET). The present invention performs this function by first determining a quantitative value for each link at an individual node in the MANET, where the value represents the current quality level of each of the links. Next, the present invention broadcasts an advertisement for each of the links in the MANET by each of the nodes, the advertisement including the value determined above. After broadcasting the advertisement, routing tables are composed at each of the nodes based upon the advertisements. Each routing table includes the value determined above. After composing the routing tables, a route based upon the routing table (and the link values contained therein) is selecting by the source node to direct the data flow to the destination node.

### FIELD OF THE INVENTION

The invention pertains to packet routing over Mobile Ad Hoc Networks (MANETs).

### BACKGROUND OF THE INVENTION

A MANET is a highly dynamic and constantly evolving network in which a collection of wireless mobile nodes form a network without any fixed infrastructure. A MANET is useful in a situation in which it is economically or physically impractical to provide a fixed infrastructure, such as for emergency workers during a hurricane or for soldiers on a battlefield. Such conditions provide no opportunity for a permanent infrastructure, which makes the mobile aspect of a MANET ideal. Efficient routing over MANETs has been a focus of research in recent years.

Quality of service (QoS) requirements of MANETs have also been a focus of research in the data networking community as interest in real-time applications over minimal infrastructure networks, such as MANETs, has increased. One specific application where QoS is of particular concern is voice over IP (VoIP). VoIP is essentially telephone service over the Internet, i.e., utilizing a data network connection to make real time telephone calls. In the two above situations, utilizing a MANET to carry VoIP data flows is beneficial as it provides contact to soldiers or emergency workers who may be far from a fixed contact point. By utilizing nodes in the MANET, the VoIP data flow can be routed to its destination despite the lack of a permanent communication infrastructure.

One popular routing protocol for MANETs is the Optimized Link State Routing (OLSR) protocol. OLSR is explained in “Optimized Link State Routing Protocol (OLSR)” by Clausen & Jacquet, RFC 3626, published October 2003, and available on the internet at “http://ietf.org/rfc/rfc3626.txt”. In a MANET, a link is any outgoing path from an individual node to another node. OLSR is a proactive routing protocol that propagates partial link state information through a MANET to support hop-by-hop packet forwarding based on the “min-hop” criterion. “Min-hop” essentially means minimum hop, or selecting a route based on the fewest hops between source and destination, regardless of the quality of the links used for each hop. Note that as long as a link is considered alive, as determined, for example, by the reception of a minimum number of hello messages in some time period, the OLSR protocol advertises it and uses it in the construction of routing tables, regardless of the quality of that link. Thus, during some topology changes, for instance, a link may go through long periods of low link quality before being considered “dead.” Any source node utilizing this advertised weak link in its routing tables risks packet delays and packet losses, both of which cause degradation to the data flow. In the above case where a MANET is used to carry a VoIP data flow, excessive packet delays and packet losses may cause an individual VoIP data flow to be completely lost.

The basic algorithm underlying routing table calculations in OLSR attempts to minimize path lengths between source-destination pairs by selecting routes with the smallest number of hops between source and destination nodes without concern for link quality. What is needed is a method of determining the quality of a link in a MANET before constructing the routing table, and advertising any available link in the routing table along with its current quality level.

### SUMMARY OF THE INVENTION

The OLSR routing protocol in a MANET is improved, in accordance with the principles of the present invention, by looking not only for a “min-hop” route, but also taking into account path quality characteristics. The routing table calculation of the OLSR protocol is adapted to utilize a calculated quality metric to evaluate links in the routing table such that paths with good quality characteristics are preferentially selected.

The quality based routing is based on the Signal-to-Noise Ratio (SNR) for packets being received at an individual node. An SNR is a measurement of the quality of the packets being received. Specifically, the SNR of a link is equal to the signal power of a transmission divided by the sum of the noise and interference powers present in the signal when received at a node. In wireless networks, such as a MANET, each node is using the same medium for transmission. As more nodes transmit, there is a greater chance of signal collisions. These collisions between data flows, or groups of packets, results in a degraded signal being received at the destination node. By measuring the SNR of a link, a node determines the present quality of each of its links and subsequently the likelihood of a data flow transmitted over that link being of a high quality. The measured SNR for different packets are averaged using a suitable averaging technique, e.g., exponential averaging. The average SNRs are maintained for each link that is considered to be “alive”, or active, according to the routing protocol.

In one embodiment of the invention, a node, after determining the average SNR for each of its links to neighboring nodes, includes in its link-state advertisements the average SNR for each of its links. When nodes in the network receive link-state advertisements and carry out routing table computations, they only consider those links for which the advertised average SNR is higher than a certain acceptable threshold. As a consequence, only good-quality links, i.e., those for which the average SNR is above the acceptable threshold, appear in routing tables.

In another embodiment of the invention, a node, after determining the average SNR for each of its links, converts these average quality values into length metrics, and includes in its link-state advertisements the length metrics for each of its links that are considered alive by the routing protocol (OLSR). Utilizing this information at the time of routing table construction, the OLSR protocol can create a routing table that can be used to find a path for a source-destination pair that minimizes the sum of length metrics of the links incident on the path. The objective of selecting routes with minimum path lengths increases the likelihood of using good-quality links, i.e., those with small length metrics, in preference to poor-quality ones with large lengths. As a consequence, to the extent possible, packets get forwarded along good-quality links.

### BRIEF DESCRIPTION OF THE DRAWINGS

FIG. 1 is a block diagram illustrating a MANET.

FIG. 2 is a flow chart illustrating the actions of a node according to one embodiment of the present invention.

FIG. 3 is a flow chart illustrating the actions of a node according to a second embodiment of the present invention.

FIG. 4 is a graph illustrating a particular link metric as a function of Signal-to-Noise Ratio as calculated in accordance with the second embodiment of the present invention.

### DETAILED DESCRIPTION OF THE INVENTION

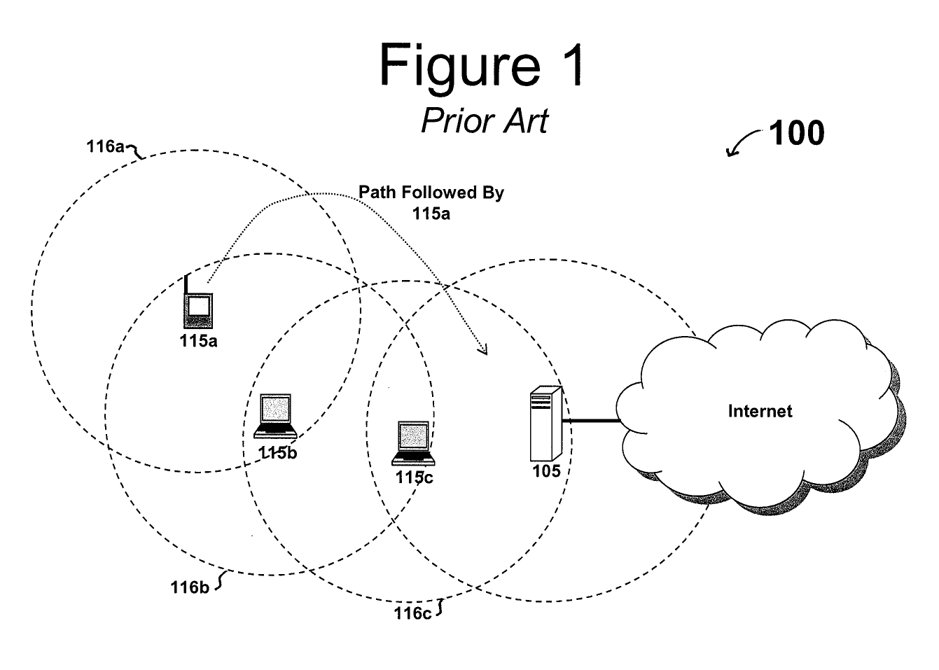

MANETs are highly dynamic, with frequent topology changes as nodes move into or out of the transmission range of other nodes. FIG. 1 illustrates MANET. Here, MANET 100 is used by mobile devices to communicate with one another and to access the Internet 107. Gateway 105 allows nodes, i.e., mobile devices, in MANET 100 to access the Internet 107.

A MANET predominantly comprises mobile devices, e.g., 115a, 115b and 115c as shown in FIG. 1. In this example, 115a is a personal digital assistance (PDA) while 115b and 115c are laptop computers. The mobile devices 115a, 115b and 115c are nodes of MANET 100. However, one feature that distinguishes a MANET from a typical wireless network, e.g., a wireless LAN, is that, in a MANET, each node acts as a source or destination of data as well as a router. Mobile devices can directly communicate with one another if they are within each other's transmission range 116; otherwise, communications between them follow a multi-hop path where data packets originating at the source node are received at intermediate nodes and then forwarded toward the destination by the intermediate nodes on the path between the source and the destination nodes. For instance, in FIG. 1, nodes 115a and 115c are not within each other's transmission range 116a and 116c. As a consequence, if node 115a wishes to communicate with node 115c, it sends its data packets to node 115b, which is within node 115a's transmission range 116a; node 115b receives these packets and transmits them to node 115c which is in its, node 115b's, transmission range 116b. As mentioned before, communications between nodes in MANET 100 and servers and devices in the Internet 107 pass through the Gateway 105. Communications between nodes of MANET 100 do not involve Gateway 105. Note that a stand-alone MANET, where the nodes communicate with one another only and not with external devices, need not include a Gateway such as the Internet Gateway 105 shown in FIG. 1.

In a realistic MANET, hundreds, or thousands of nodes may be present. A remote node may have numerous routes to use to connect to another node, or an Internet Gateway such as 105 in FIG. 1. Typical routing techniques utilize a minimum hop routing protocol, where a source-destination route is chosen based upon the smallest number of hops, or intermediate nodes, between the source and destination nodes. This technique ignores the current conditions of the network such as individual link traffic and overall performance of individual nodes.

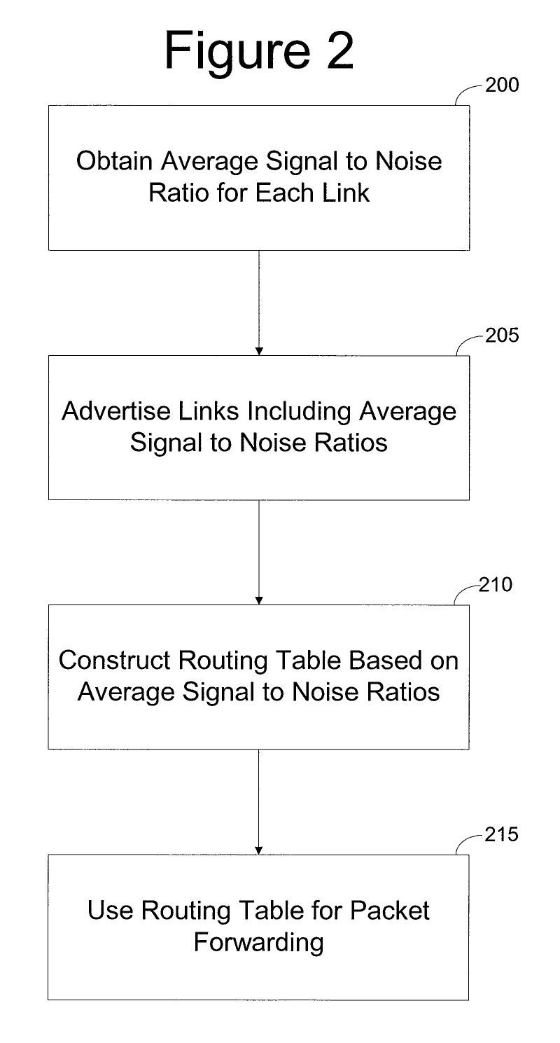

FIG. 2 illustrates a flow diagram of the actions at a node in accordance with one of the embodiments of the present invention utilizing Signal-to-Noise Ratio based link selection to find optimal routes through a MANET. In step 200, the node calculates the average SNR for each of its links. As discussed above, the quality of packets received at a particular node may be affected by the physical conditions of the link being used to transmit the packets. In a MANET, numerous nodes are transmitting via the same medium, which can cause SNR to fall, resulting in poor quality links. For each packet received at a node, the SNR is recorded. Since SNR values exhibit a great deal of variation, steps must be taken to generate relatively stable SNR estimates. A suitable averaging technique can be employed to derive an estimate of the average SNR from the individual SNR values recorded for each packet.

Once a node has obtained an average SNR for each of its links that are considered alive, the process proceeds to step 205. At step 205, each node advertises its links with its neighboring nodes. For example, when utilizing OLSR as the routing protocol, the link advertisements take place in “Hello” messages and “Topology Control” messages. The link advertisements include, for each link, a suitably quantized value of the corresponding average SNR as well. By attaching this average SNR along with an availability advertisement, other nodes will have the option of only selecting a route that includes only those links that are currently exhibiting high SNR values.

After the advertising phase, the process continues to step 210. At this step, each node in the MANET constructs a routing table using the link advertisements it has received from other nodes in the network. In one embodiment, while constructing a routing table, a node considers only those links for which the average SNR is greater than a predetermined acceptance threshold. Depending on the chosen encoding/modulation scheme used by the nodes in the MANET, the predetermined acceptance threshold can vary from one MANET to another. However, regardless of how the acceptance threshold is determined, links with the best SNR values will be chosen by a source node if they fit into a source-destination route.

The routing table construction can be based on any additional suitable criterion such as minimizing hop count for every source-destination pair. The only requirement placed on the routing table construction is that only those links with average SNR values greater than the acceptance threshold be considered for routes within the MANET. Once the routing tables are constructed, packets are forwarded within the network along the routes given by the routing tables (step 215).

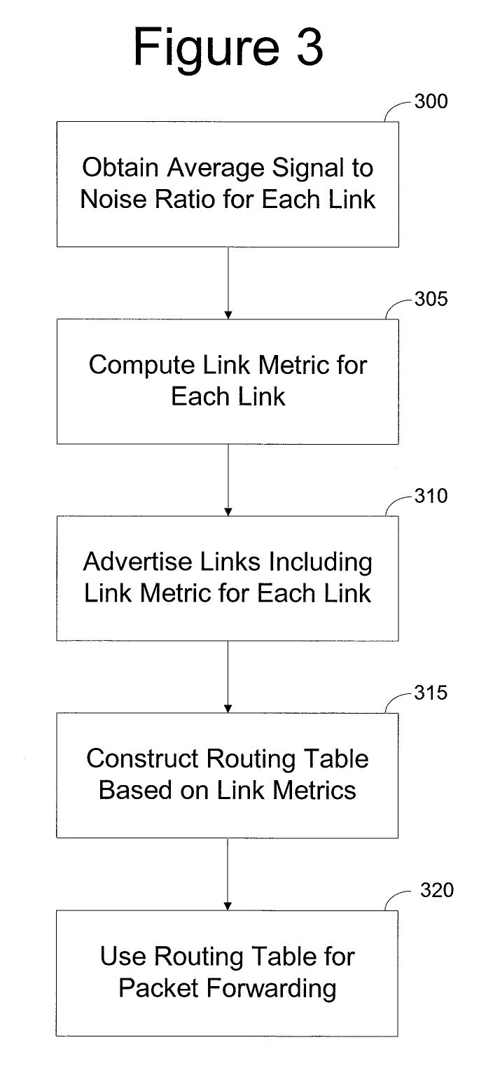

FIG. 3 illustrates a flow diagram of a second embodiment of the present invention. Step 300 of the flow diagram in FIG. 3 is identical to step 200 of the flow diagram of FIG. 2. Here, in Step 300 of FIG. 3, too, each node obtains an estimate of the average SNR for each of its outbound links. The methods/algorithms described in the context of Step 200 of FIG. 2 can be employed here as well.

Following Step 300, each node proceeds to Step 305 where it computes a length metric for each of its outbound links. The length metric for a link is a monotonically non-increasing function of the corresponding average SNR. The equation given below is one example of a conversion equation that takes an estimated average SNR and converts it to a corresponding length metric:

$$LinkMetric = trunc [ 1.5 + \frac{B}{2} - \frac{B}{π} {tan}^{- 1} ( C ( SNR - A ) ) ]$$

where A, B and C are constants chosen based on the desired performance of the MANET. For instance, if a 4-bit length metric is desired, B can be set to 14 so that the length metric ranges from 1 to 15. A depends on the modulation and coding scheme being used. If, for the modulation-coding scheme being used, it is found that the packet error rate deteriorates sharply when SNR falls below 10 dB, A may be set at 10. C determines the shape of the curve. A large value of C will yield a curve that drops sharply as the SNR approaches A. A small value of C will yield a more gently dropping curve. C should be chosen such that, for the given modulation-coding scheme, as the packet error rate varies from, for example, 90% to 10%, the corresponding change in the link metric is around 80% or so, resulting in a value of 0.8 for C.

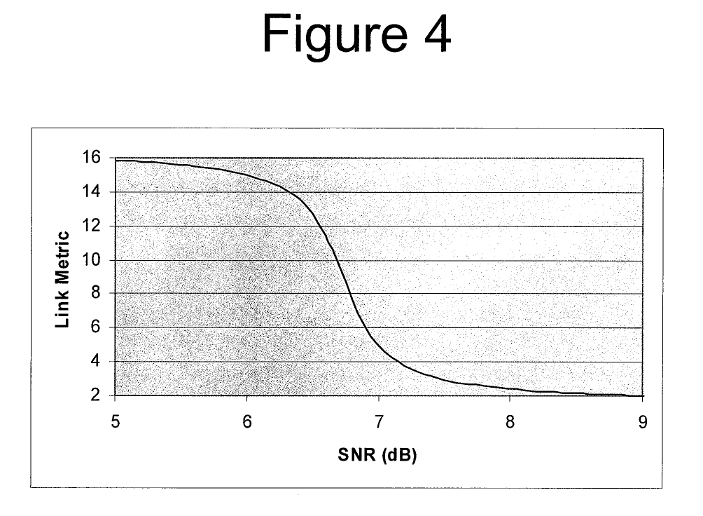

FIG. 4 shows an exemplary graph of the length metric as a function of the average SNR as calculated by the above equation using the above values, i.e., A=10, B=14 and C=0.8. In this example, the lower the length metric the higher the SNR is for each link. Thus, a link with a lower length metric is operating with a high SNR and can be looked upon as better suited for inclusion in routing tables.

Referring again to FIG. 3, once a node has obtained length metrics for each of its outbound links, the process proceeds to step 310. At step 310, each node advertises its links along with the corresponding length metrics.

After the advertising phase, the process continues to step 315. At this step, each node in the MANET constructs a routing table using the link advertisements it has received from other nodes in the network. The routing tables are constructed using an algorithm that minimizes path lengths to all destinations within the network. The path lengths in this computation are the sums of the length metrics of the links comprising those paths. Once routing tables are constructed, packets are forwarded within the network along the routes given by the routing tables (step 320). This increases the likelihood that packets will be mostly forwarded along links with small length metrics, i.e. those with higher SNR values.

By utilizing routing tables, the construction of which takes into account the predicted SNR associated with links, the present invention overcomes obvious problems in the prior art. Specifically, in the prior art, a link with low SNR was considered for packet forwarding regardless of its impact on the quality loss suffered by data packets as they were routed toward the destination. With the present invention, such links are either never considered for packet forwarding or the likelihood of such links being used for packet forwarding is significantly reduced. In either case, one can expect substantial reduction in the end-to-end quality loss experienced by data packets as they are forwarded toward their destinations in a MANET.

It should be clear to persons familiar with the related arts that the processes, procedures and/or steps of the invention described herein can be performed by a programmed computing device running software designed to cause the computing device to perform the processes, procedures and/or steps described herein. These processes, procedures and/or steps also could be performed by other forms of circuitry including, but not limited to, application-specific integrated circuits, logic circuits and state machines.

The embodiments shown above are merely shown by way of example. One of ordinary skill in the art will recognize additional embodiments and advantages not fully illustrated above. For example, a different equation can be used to calculate a link's length metric or a different SNR acceptance threshold can be set for each link. Accordingly, the breadth and scope of the present invention should be defined only in accordance with the following claims and their equivalents.

1. A method for routing a data flow in a mobile ad-hoc network (MANET) comprising a plurality of nodes and a plurality of links between at least various ones of said nodes of said MANET, the method comprising the steps of:
determining a quantitative value representing the current signal quality level for each link at a node where said link originates in said MANET;
for each of said links in said MANET, broadcasting from at least its respective originating node said value;
composing a routing table at each of said nodes based upon said values contained in received broadcasts; and
forwarding at least on packet received at one of said nodes in accordance with said node's routing table.

2. The method of claim 1, wherein said value is broadcast in a link state advertisement.

3. The method of claim 2, wherein said value is an average Signal-to-Noise Ratio (SNR) for each link.

4. The method of claim 2, wherein said value is a link metric calculated based upon an average SNR for each link.

5. The method of claim 4, wherein said link metric is calculated using the following equation:
$$LinkMetric = trunc [ 1.5 + \frac{B}{2} - \frac{B}{π} {tan}^{- 1} ( C ( SNR - A ) ) ]$$
wherein:
A is a level where link signal quality falls below an accepted level for each of said links;
B is a total number of possible link metric values;
C is a slope of a curve of a graphical representation of said equation; and
SNR represents the average SNR of said link.

6. The method of claim 1, wherein said data flow is a voice over IP (VoIP) data flow.

7. The method of claim 1, wherein said value represents a signal quality level of an entire node.

8. The method of claim 1, wherein said value represents a signal quality level of an individual link.

9. A method for routing a data flow from a source node to a destination node in a mobile ad-hoc network (MANET) comprising a plurality of nodes and a plurality of links between nodes of said MANET, the method comprising the steps of:
each node in said MANET calculating an average SNR value for each link;
said nodes in said MANET advertising each of said links, said advertisement including said average SNR;
each of said nodes composing a routing table based upon said advertisements, said routing table being based on said links in said MANET and said average SNR values; and
selecting a route at a source node to direct said data flow from said source node to said destination node based upon said routing table.

10. The method of claim 9, wherein said data flow is a VoIP data flow.

11. A system for routing a data flow in a mobile ad-hoc network (MANET) comprising a plurality of nodes and a plurality of links between at least various ones of said nodes of said MANET, the system comprising:
means for determining a quantitative value representing the current signal quality level for each link at a node where said link originates in said MANET;
for each of said links in said MANET, means for broadcasting from at least its respective originating node said value;
means for composing a routing table at each of said nodes based upon said values contained in received broadcasts; and
means for forwarding at least on packet received at one of said nodes in accordance with said node's routing table.

12. The system of claim 11, wherein said value is broadcast in a link state advertisement.

13. The system of claim 12, wherein said value is an average Signal-to-Noise Ratio (SNR) for each link.

14. The system of claim 12, wherein said value is a link metric calculated based upon an average SNR for each link.

15. The system of claim 14, wherein said link metric is calculated using the following equation:
$$LinkMetric = trunc [ 1.5 + \frac{B}{2} - \frac{B}{π} {tan}^{- 1} ( C ( SNR - A ) ) ]$$
wherein:
A is a level where link signal quality falls below an accepted level for each of said links;
B is a total number of possible link metric values;
C is a slope of a curve of a graphical representation of said equation; and
SNR represents the average SNR of said link.

16. The system of claim 11, wherein said data flow is a voice over IP (VoIP) data flow.

17. The system of claim 11, wherein said value represents a signal quality level of an entire node.

18. System of claim 11, wherein said value represents a signal quality level of an individual link.

19. A computer readable product embodied on a computer readable medium for routing a data flow in a mobile ad-hoc network (MANET) comprising a plurality of nodes and a plurality of links between at least various ones of said nodes of said MANET, comprising:
first computer executable instructions for determining a quantitative value representing the current signal quality level for each link at a node where said link originates in said MANET;
second computer executable instructions for broadcasting from at least its respective originating node said value for each of said links in said MANET;
third computer executable instructions for composing a routing table at each of said nodes based upon said values contained in received broadcasts; and
fourth computer executable instructions for forwarding at least one packet received at one of said nodes in accordance with said node's routing table.

20. The product of claim 19, wherein said value is broadcast in a link state advertisement.

21. The product of claim 20, wherein said source node selects a route to said destination node based upon said routing table.

22. The product of claim 21, wherein said value is an average SNR for each link.

23. The product of claim 21, wherein said value is a link metric calculated based upon an average SNR for each link.

24. The product of claim 23, wherein said link metric is calculated using the following equation:
$$LinkMetric = trunc [ 1.5 + \frac{B}{2} - \frac{B}{π} {tan}^{- 1} ( C ( SNR - A ) ) ]$$
wherein:
A is a level where link signal quality falls below an accepted level for each of said links;
B is a total number of possible link metric values;
C is a slope of a curve of a graphical representation of said equation; and
SNR represents the average SNR of said link.

25. The method of claim 21, wherein said data flow is a voice over IP (VoIP) data flow.
